(19) United States
(12) Patent Application Publication
(10) Pub. No.: US 2024/0355521 A1
(43) Pub. Date: Oct. 24, 2024

(54) SPIN INDUCTOR

(71) Applicant: TDK CORPORATION, Tokyo (JP)

(72) Inventors: Tomoyuki SASAKI, Tokyo (JP); Katsuyuki NAKADA, Tokyo (JP); Kaito ASAI, Tokyo (JP)

(73) Assignee: TDK CORPORATION, Tokyo (JP)

(21) Appl. No.: 18/034,798

(22) PCT Filed: Sep. 30, 2022
(86) PCT No.: PCT/JP2022/036685

§ 371 Date: May 1, 2023

(51) Int. Cl. H01F 17/00; H01F 27/29

(52) U.S. Cl. CPC H01F 17/0013; H01F 27/292; H01F 2017/0066

(57) ABSTRACT

A spin inductor has a first inductor layer, a first terminal, and a second terminal. The first inductor layer includes a first wiring layer and a first ferromagnetic layer in contact with the first wiring layer. The first terminal is in contact with a first lateral surface of the first inductor layer. The second terminal is in contact with a second lateral surface that is different from the first lateral surface of the first inductor layer. A virtual plane that connects a top edge and a bottom edge of the first lateral surface is inclined in the laminating direction.

### TECHNICAL FIELD

The present invention relates to a spin inductor.

### BACKGROUND ART

Along with resistors or capacitors, inductors are major electronic parts and are used in various types of electronic equipment. A coil is an example of an inductor. There is a trade-off relation between the size of a coil and the intensity of inductance and it is difficult to achieve large inductance with a small coil.

In recent years, with the development of spintronics technology, new inductors using spins have been attracting attention (for example, Non-Patent Document 1). The inductors using spins are attracting attention because the inductance intensity is increased as the element size is reduced and it is possible to achieve both miniaturization and inductance intensity.

### CITATION LIST

### Non-Patent Document

### Non-Patent Document 1

Yuta Yamane, Shunsuke Fukami, and Junichi Ieda, Physical Review Letters 128, 147201 (202).

### SUMMARY OF INVENTION

### Technical Problem

A miniaturized spin inductor has a structure in which thin films are laminated. In order to stably flow a current in a layer of the thin film, it is necessary to ensure electrical connection between an electrode and the thin film.

In consideration of the above-mentioned circumstance, the present invention is directed to providing a spin inductor that is electrically stable.

### Solution to Problem

The present invention provides the following means in order to solve the above-mentioned problems.

(1) A spin inductor according to a first aspect has a first inductor layer, a first terminal, and a second terminal. The first inductor layer includes a first wiring layer and a first ferromagnetic layer in contact with the first wiring layer. The first terminal is in contact with a first lateral surface of the first inductor layer. The second terminal is in contact with a second lateral surface different from the first lateral surface of the first inductor layer. A virtual plane that connects a top edge and a bottom edge of the first lateral surface is inclined in the laminating direction.

(2) In the spin inductor according to the aspect, each of the first terminal and the second terminal is in contact with both the first wiring layer and the first ferromagnetic layer.

(3) The spin inductor according to the aspect may further include a spacer layer in contact with the first inductor layer.

(4) The spin inductor according to the aspect may further include a second inductor layer including a second wiring layer and a second ferromagnetic layer in contact with the second wiring layer. The spacer layer is sandwiched between the first ferromagnetic layer and the second wiring layer.

(5) In the spin inductor according to the aspect, the first wiring layer may have a length in a first direction in which the first terminal and the second terminal are connected, which is smaller than a length in a second direction perpendicular to the first direction.

(6) In the spin inductor according to the aspect, the first lateral surface may have a stepped shape.

(7) In the spin inductor according to the aspect, the first lateral surface may be an inclined surface.

(8) The spin inductor according to the aspect may further include a first yoke layer. The first yoke layer is separated from the first inductor layer in the laminating direction.

(9) The spin inductor according to the aspect may further include a second yoke layer. The first yoke layer and the second yoke layer sandwich the first inductor layer in the laminating direction.

(10) The spin inductor according to the aspect may further include a via that connects the first yoke layer and the second yoke layer.

(11) In the spin inductor according to the aspect, the first inductor layer may have a first region in contact with the first terminal. In the first region, at least one of the first wiring layer and the first ferromagnetic layer contains an atom that constitutes the first terminal.

(12) In the spin inductor according to the aspect, the first wiring layer may be configured to inject spins into the first ferromagnetic layer and be capable of causing precession of magnetization of the first ferromagnetic layer.

### Advantageous Effects of Invention

A spin inductor according to the present invention is electrically stable.

### BRIEF DESCRIPTION OF DRAWINGS

FIG. 1 is a perspective view of a spin inductor according to a first embodiment.

FIG. 2 is a cross-sectional view of the spin inductor according to the first embodiment.

FIG. 3 is a plan view of the spin inductor according to the first embodiment.

FIG. 4 is a schematic perspective view of a first inductor layer according to the spin inductor according to the first embodiment.

FIG. 5 is a cross-sectional view of a spin inductor according to a second embodiment.

FIG. 6 is a cross-sectional view of a spin inductor according to a third embodiment.

FIG. 7 is a perspective view of a spin inductor according to a fourth embodiment.

FIG. 8 is a cross-sectional view of the spin inductor according to the fourth embodiment.

FIG. 9 is a plan view of the spin inductor according to the fourth embodiment.

### DESCRIPTION OF EMBODIMENTS

Hereinafter, embodiments of the present invention will be appropriately described in detail with reference to the accompanying drawings. In the drawings used in the following description, the characteristic sections may be enlarged for convenience in order to make the characteristics easier to understand, and a dimensional ratio of each component may differ from the actual one. The materials dimensions, or the like exemplified in the following description are examples, the present invention is not limited to them, and it is possible to change them appropriately within the scope in which the effect of the present invention is exhibited.

First, directions will be defined. A direction of a surface in which each layer extends is referred to as an x direction, and a direction perpendicular to the x direction is referred to as a y direction. For example, a first direction in which a first terminal 60 and a second terminal 70 are connected is referred to as the x direction. A second direction perpendicular to the first direction is referred to as, for example, the y direction. In addition, a thickness direction of each layer is referred to as a z direction. The z direction is perpendicular to the x direction and the y direction.

### First Embodiment

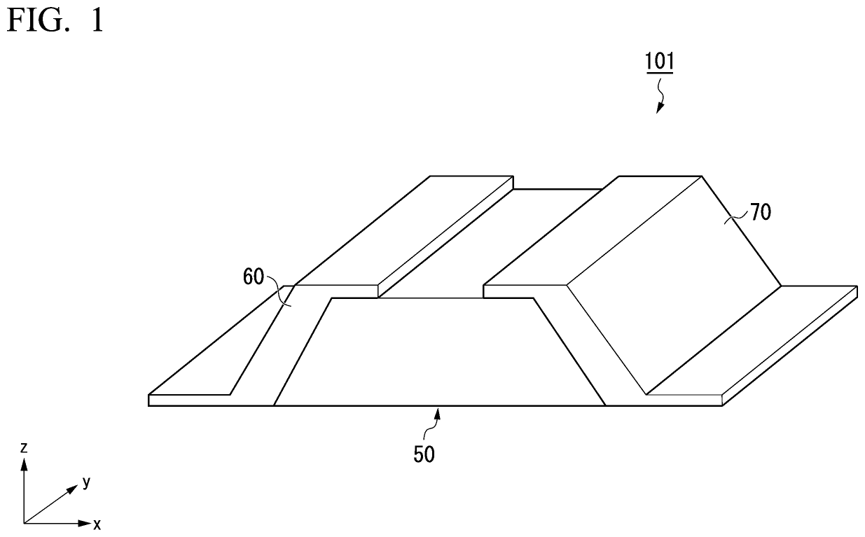

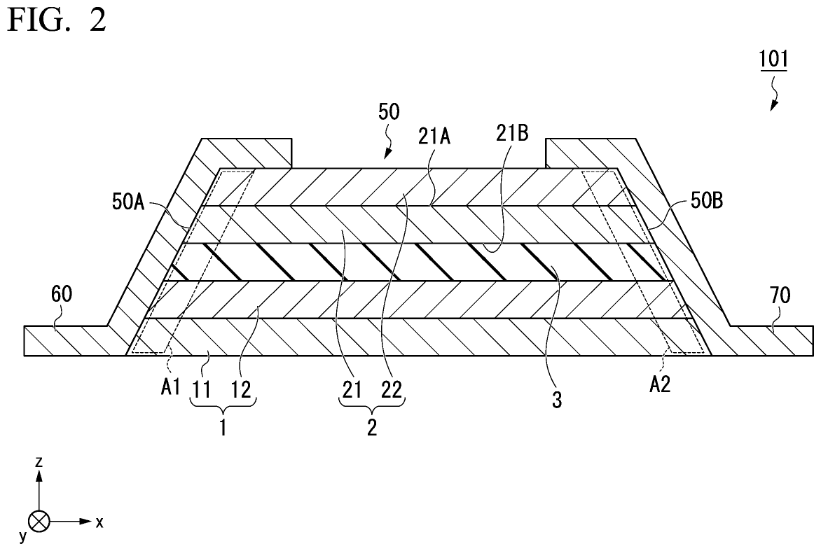

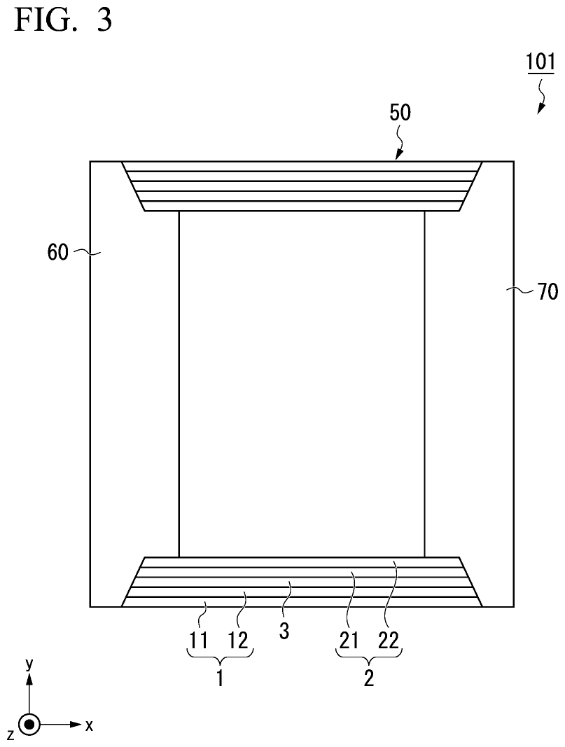

FIG. 1 is a perspective view of a spin inductor 101 according to a first embodiment. FIG. 2 is a cross-sectional view of the spin inductor 101 according to the first embodiment. FIG. 3 is a plan view of the spin inductor 101 according to the first embodiment.

The spin inductor 101 cuts a high frequency component of the current and passes an invariant component of the current. The current flows between the first terminal 60 and the second terminal 70. The spin inductor 101 is disposed in a section where a high frequency current is to be cut. While the high frequency current is cut by the spin inductor 101, direct current flows through the spin inductor 101. For direct current, the spin inductor 101 is a resistor.

The spin inductor 101 has a laminated body 50, the first terminal 60, and the second terminal 70.

The first terminal 60 is in contact with a first lateral surface 50A of the laminated body 50. The first terminal 60 is in contact with the laminated body 50 over a first wiring layer 11 and a first ferromagnetic layer 12.

The first lateral surface 50A is inclined in the z direction. The first lateral surface 50A is inclined with respect to a yz plane. The first lateral surface 50A coincides with a virtual plane that connects a first end side of an upper surface of the laminated body 50 in the x direction and a first end side of a lower surface of the laminated body 50 in the x direction.

The first terminal 60 is a conductor. The current flows from the first terminal 60 to the laminated body 50. The laminated body 50 is a laminated body obtained by laminating thin films. As the first lateral surface 50A is inclined, a contact area between the thin film that constitute the laminated body 50 and the first terminal 60 increases, and electrical connection between the thin film that constitute the laminated body 50 and the first terminal 60 is stabilized.

The second terminal 70 is in contact with a second lateral surface 50B of the laminated body 50. The second lateral surface 50B is a lateral surface different from the first lateral surface 50A of the laminated body 50. The second lateral surface 50B is, for example, a lateral surface facing the first lateral surface 50A of the laminated body 50. The second terminal 70 is in contact with the laminated body 50 over the first wiring layer 11 and the first ferromagnetic layer 12.

The second lateral surface 50B is inclined in the z direction. The second lateral surface 50B is inclined with respect to the yz plane. The second lateral surface 50B coincides with a virtual plane that connects a second end side of an upper surface of the laminated body 50 in the x direction and a second end side of a lower surface of the laminated body 50 in the x direction. A direction inclined with respect to the yz plane of the second lateral surface 50B is opposite to a direction inclined with respect to the yz plane of the first lateral surface 50A.

The second terminal 70 is a conductor. The current flows from the laminated body 50 to the second terminal 70. As the second lateral surface 50B is inclined, a contact area between the thin film that constitute the laminated body 50 and the second terminal 70 increases and electrical connection between the thin film that constitute the laminated body 50 and the second terminal 70 is stabilized.

The laminated body 50 includes a first inductor layer 1, a second inductor layer 2, and a spacer layer 3. Here, while the case in which the inductor layers are two layers has been shown, the number of inductor layers may be two layers or more. The spacer layer is sandwiched between the adjacent inductor layers.

The laminated body 50 has a first region A1 in contact with the first terminal 60. In the first region A1, at least one of the first wiring layer 11 and the first ferromagnetic layer 12 may contain an atom that constitutes the first terminal 60. In addition, the laminated body 50 has a second region A2 in contact with the second terminal 70. In the second region A2, at least one of the first wiring layer 11 and the first ferromagnetic layer 12 may contain an atom that constitutes the second terminal 70. When the first region A1 contains the atom that constitutes the first terminal 60, contact resistance between the first terminal 60 and the laminated body 50 decreases. In addition, when the second region A2 contains the atom that constitutes the second terminal 70, contact resistance between the second terminal 70 and the laminated body 50 decreases.

The first inductor layer 1 includes the first wiring layer 11 and the first ferromagnetic layer 12. The second inductor layer 2 includes a second wiring layer 21 and a second ferromagnetic layer 22. Even when the inductor layers are two layers or more, each of the inductor layers includes a wiring layer and a ferromagnetic layer.

The first wiring layer 11 has, for example, a length in the x direction smaller than a length in the y direction. The second wiring layer 21 has, for example, a length in the x direction smaller than a length in the y direction. The laminated body 50 has, for example, a length in the x direction smaller than a length in the y direction. When the length of the wiring layer in the y direction is increased, a current density of the current flowing through the wiring layer is reduced. In addition, when the length of the wiring layer in the x direction is small, the spin inductor 101 has a low resistance.

The first wiring layer 11 contains any one of a metal, an alloy, intermetallic compound, metal boride, metal carbide, metal silicate, and metal phosphide, which have a function of generating spin current using a spin Hall effect when the current flows. The first wiring layer 11 is referred to as spin-orbit-torque wiring.

The first wiring layer 11 contains, for example, a non-magnetic heavy metal as a main component. The heavy metal means a metal having a specific weight greater than that of yttrium (Y). The non-magnetic heavy metal is a non-magnetic metal having an atomic number greater than an atomic number of 39 or more having, for example, d electrons or f electrons on the outermost shell. The first wiring layer 11 is formed of, for example, Hf, Ta or W. The non-magnetic heavy metal causes stronger spin-orbit interaction than other metals. A spin Hall effect is generated by the spin-orbit interaction. When the spins are likely to be concentrated in the first wiring layer 11 by the spin Hall effect, spin current J_{S} tends to occur.

The first wiring layer 11 may additionally include a magnetic metal. The magnetic metal is a ferromagnetic metal or an antiferromagnetic metal. A small amount of magnetic metal contained in the non-magnetic body is a scattering factor of the spins. The small amount is, for example, 3% or less of a total molar ratio of an element that constitutes the wiring layer. When the spins are scattered by the magnetic metal, the spin-orbit interaction is enhanced, and generation efficiency of the spin current with respect to the current is increased.

The first wiring layer 11 may include a topological insulator. The topological insulator is a material whose interior is an insulator or a high resistance body, but whose surface has a spin-polarized metallic state. The topological insulator produces an internal magnetic field using the spin-orbit interaction. The topological insulator develops a new topological phase due to the effect of the spin-orbit interaction even when there is no external magnetic field. The topological insulator can generate a pure spin current with high efficiency using the strong spin-orbit interaction and breaking of inversion symmetry at the edge.

The topological insulator is, for example, Sn, SnTe, Bi_{1.5}Sb_{0.5}Te_{1.7}Se_{1.3}, TlBiSe₂, Bi₂Te₃, Bi₁₋ₓSbₓ, (Bi₁₋ₓSbₓ)₂Te₃, or the like. The topological insulator can generate a spin current with high efficiency.

The first ferromagnetic layer 12 is in contact with the first wiring layer 11. The first ferromagnetic layer 12 covers, for example, the entire upper surface of the first wiring layer 11 when seen in the z direction.

The first ferromagnetic layer 12 is a ferromagnetic body. The ferromagnetic body is, for example, a metal selected from the group consisting of Cr, Mn, Co, Fe and Ni, an alloy containing one or more of these metals, an alloy containing these metals and at least one or more elements of B, C, and N, or the like.

The ferromagnetic body is, for example, Co—Fe, Co—Fe—B, Ni—Fe, Co—Ho alloy, Sm—Fe alloy, Fe—Pt alloy, Co—Pt alloy, or CoCrPt alloy. The CoCrPt alloy and L1₀ type CoFe alloy have large saturated magnetization and strong magnetic anisotropy, and when these are used in the first ferromagnetic layer 12, a resonance frequency of the spin inductor 101 is increased.

The second wiring layer 21 contains the same material as the first wiring layer 11. The second ferromagnetic layer 22 contains the same material as the first ferromagnetic layer 12. When the inductor layers are greater than two layers, each of the wiring layers includes and the same material as the first wiring layer 11 and each of the ferromagnetic layers includes the same material as the first ferromagnetic layer 12. The materials that constitute the wiring layers may be the same as or may be different from each other. The materials that constitute the ferromagnetic layers may be the same as or may be different from each other.

The spacer layer 3 is provided between the first inductor layer 1 and the second inductor layer 2. When the inductor layers are two layers or more, the spacer layer 3 is disposed between the adjacent inductor layers. For example, the spacer layer 3 is disposed between the first ferromagnetic layer 12 and the second wiring layer 21.

The spacer layer 3 breaks symmetry of the second wiring layer 21 in the z direction. The second ferromagnetic layer 22 in contact with a first surface 21A of the second wiring layer 21 is different from the spacer layer 3 in contact with a second surface 21B. For example, the second ferromagnetic layer 22 in contact with the first surface 21A and the spacer layer 3 in contact with the second surface 21B are different in any one of a crystal structure, a composition, and a material. When the layers in contact with the first surface 21A and the second surface 21B of the second wiring layer 21 are different, symmetry of the second wiring layer 21 in the z direction is broken. When the symmetry of the second wiring layer 21 is broken, an amount of spins injected into the second ferromagnetic layer 22 from the second wiring layer 21 is increased.

The spacer layer 3 includes a non-magnetic body. The spacer layer 3 may be, for example, an insulator. The spacer layer 3 may use, for example, Al₂O₃, SiO₂, MgO, MgAl₂O₄, and the like. In addition, in addition to these, a material obtained by substituting some of Al, Si and Mg with Zn, Be, or the like, may be used.

When the spacer layer 3 is the insulator, it is possible to suppress the spins from being injected into the first ferromagnetic layer 12 from the second wiring layer 21. The polarization direction of the spins injected into the first ferromagnetic layer 12 from the second wiring layer 21 is opposite to the polarization direction of the spins injected into the first ferromagnetic layer 12 from the first wiring layer 11, which causes disturbance in the precession of magnetization M1 of the first ferromagnetic layer 12. In addition, when the spacer layer 3 is the insulator, no current flows through the spacer layer 3, the amount of the current flowing through the first wiring layer 11 and the second wiring layer 21 can be increased, and inductance of the spin inductor 101 can be increased.

The spacer layer 3 may be, for example, a semiconductor. The semiconductor is, for example, Si, Ge, CuInSe₂, CuGaSe₂, Cu(In,Ga)Se₂, or the like.

When the spacer layer 3 is the semiconductor, capacitance between the first inductor layer 1 and the second inductor layer 2 can be reduced. When the capacitance is small, even though a high frequency current is applied, the spin inductor 101 can exhibit the function of the inductor.

The spacer layer 3 may be, for example, a conductor. The spacer layer 3 may contain, for example, any one of selected from the group consisting of Cu, Al and Ag. The spacer layer 3 may be, for example, any one of Cu, Al and Ag. When the spacer layer 3 is the conductor, the resistance of the entire spin inductor 101 can be lowered. In addition, when the spacer layer 3 is the conductor, the capacitance between the first inductor layer 1 and the second inductor layer 2 is reduced.

A film thickness of the spacer layer 3 is smaller than, for example, the thickness of each of the first wiring layer 11 and the second wiring layer 21. By reducing the film thickness of the spacer layer 3, it is possible to prevent a large amount of current from flowing to the spacer layer 3 and to increase the inductance of the spin inductor 101.

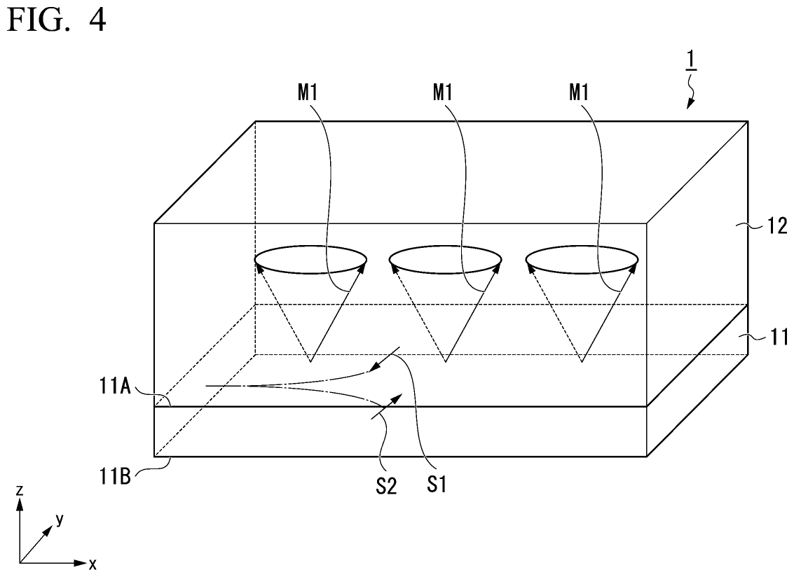

Next, a function of the spin inductor 101 will be described. FIG. 4 is a schematic view showing movement of the magnetization M1 and spins S1 and S2 in the first inductor layer 1.

The first inductor layer 1 is a part of the laminated body 50. The current is applied to the first inductor layer 1 from the first terminal 60 or the second terminal 70. The current applied from the first terminal 60 or the second terminal 70 flows through the surface of the first inductor layer 1.

The first wiring layer 11 generates a spin current using a spin Hall effect when the current flows, and injects spins into the first ferromagnetic layer 12.

The spin Hall effect is a phenomenon in which a spin current is induced in a direction (for example, the z direction) perpendicular to the direction in which the current flows based on the spin-orbit interaction when the current flows. The spin Hall effect is similar to a normal Hall effect in that moving (shifting) electric charges (electrons) bend a moving (shifting) direction. In the normal Hall effect, the moving direction of the charged particles moving in the magnetic field is bent by the Lorentz force. On the other hand, in the spin Hall effect, even when there is no magnetic field, the moving direction of the spins is bent by shifting the electron (just flowing the current).

For example, when the current flows in the x direction of the first wiring layer 11, for example, the spin S1 polarized in a −y direction is bent in a +z direction with respect to a direction of advance, and the spin S2 polarized in a +y direction is bent in a −z direction with respect to a direction of advance. The spin S1 is concentrated on a first surface 11A, and the spin S2 is concentrated on a second surface 11B. The spins accumulated on the first surface 11A are injected into the adjacent layers. The spin S1 is injected into the first ferromagnetic layer 12 from the first surface 11A of the first wiring layer 11.

The first ferromagnetic layer 12 has the magnetization M1. Precession of the magnetization M1 of the first ferromagnetic layer 12 is performed by the spin S1 injected from the first wiring layer 11.

When the precession of the magnetization M1 of the first ferromagnetic layer 12 is performed, energy conversion is generated between the magnetic moment and the current, and the spin inductor 101 exhibits an inductor function.

The magnetization M1 of the first ferromagnetic layer 12 preferably has a component oriented in the z direction in an initial state, and more preferably oriented in the z direction. The initial state is a state in which no current flows through the first wiring layer 11 and no external magnetic field is applied.

When the magnetization M1 has the component in the z direction, the magnetization M1 is likely to maintain the precession. For example, when the magnetization M1 is oriented in the x direction or the y direction, even in a state in which no external magnetic field is applied, the magnetization reversal may occur and the precession of the magnetization may be not maintained. Since the spin inductor 101 exhibits an inductor function using energy conversion between the magnetic moment and the current, when the precession of the magnetization is stopped, the inductor function is not sufficiently exhibited.

Further, even when the magnetization M1 is oriented in the x direction or the y direction, it is possible to maintain the precession of the magnetization by adjusting the density of the current flowing through the first wiring layer 11.

By the same principle, when the current flows in the x direction of the second wiring layer 21, the spins are injected into the second ferromagnetic layer 22 from the second wiring layer 21. The precession of the magnetization of the second ferromagnetic layer 22 is performed by the spins injected from the second wiring layer 21. The magnetization of the second ferromagnetic layer 22 preferably has a component oriented in the z direction in the initial state, and more preferably oriented in the z direction. When the inductor layers are more than two layers, each of the inductor layers functions in the same principle.

Since the spin inductor 101 generates a resonance phenomenon at a ferromagnetic resonance frequency of the first ferromagnetic layer 12, it is difficult for the spin inductor 101 to stably operate as the inductor in the vicinity of the resonance frequency. Accordingly, the spin inductor 101 is used at a frequency substantially lower or higher than the ferromagnetic resonance frequency of the spin inductor 101. The substantially low frequency or the substantially high frequency shows a frequency deviated by substantially 5% or more of the ferromagnetic resonance frequency with reference to the ferromagnetic resonance frequency.

The spin inductor 101 according to the first embodiment exhibits a function as the inductor by performing the precession of the magnetization of the ferromagnetic layer by the spins injected from the wiring layer. In addition, the spin inductor 101 can stably supply the current to the thin wiring layer because the contact area between the first terminal 60 and the laminated body 50 is substantially great.

In addition, the spin inductor 101 has a low resistance by laminating the plurality of inductor layers. The spin inductor 101 has a low resistance because a plurality of parallel routes are formed between the first terminal 60 and the second terminal 70.

In addition, the spin inductor 101 can increase the amount of the spins injected into the ferromagnetic layer from the wiring layer because the spacer layer 3 breaks the symmetry of the wiring layer in the z direction.

In addition, since the spin inductor according to the first embodiment exhibits the inductor function using energy conversion between the current and the magnetic moment, strong inductance can be exhibited also by the miniaturized spin inductor. For example, even when the maximum width of the laminated body 50 when seen in a plan view in the z direction is 0.003 mm or less, it is possible to exhibit the inductance of 0.1 μH or more and 10 μH or less. The miniaturized inductance element is particularly required in a region where it is difficult to incorporate large elements such as the universe and cryogenics.

### Second Embodiment

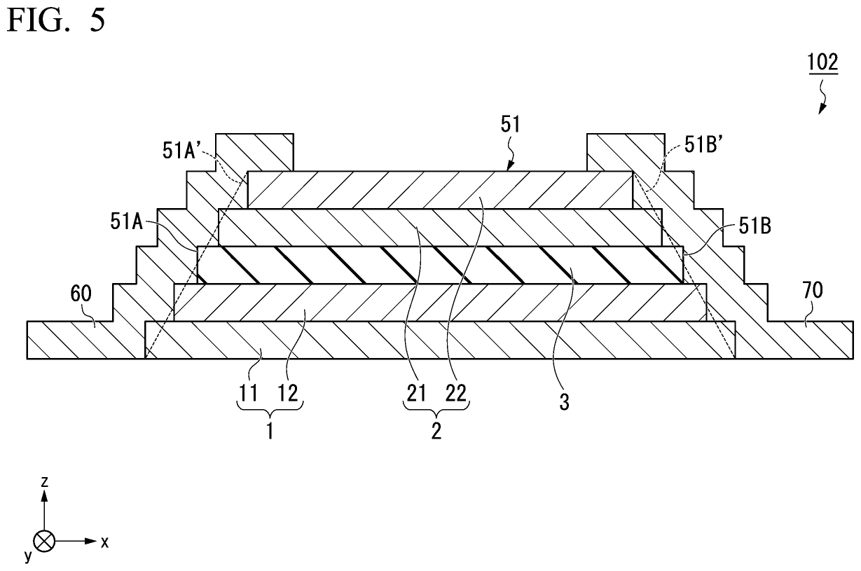

FIG. 5 is a cross-sectional view of a spin inductor 102 according to a second embodiment. In the spin inductor 102 according to the second embodiment, the same components as in the spin inductor 101 according to the first embodiment are designated by the same reference signs, and description thereof will be omitted.

The spin inductor 102 according to the second embodiment has a laminated body 51, a first terminal 60, and a second terminal 70. The laminated body 51 distinguished from the first lateral surface 50A and the second lateral surface 50B of the laminated body 50 in that a first lateral surface 51A and a second lateral surface 51B have stepped shapes. The laminated body 51 may have the first region Al and the second region A2 like in the laminated body 50.

A virtual plane 51A′ that connects a first end side of an upper surface of the laminated body 51 in the x direction and a first end side of a lower surface of the laminated body 51 in the x direction is inclined in the z direction. The virtual plane 51A′ is inclined in the z direction. The virtual plane 51A′ is inclined with respect to the yz plane.

A virtual plane 51B′ that connects a second end side of the upper surface of the laminated body 51 in the x direction and a second end side of the lower surface of the laminated body 51 in the x direction is inclined in the z direction. The virtual plane 51B′ is inclined in the z direction. The virtual plane 51B′ is inclined with respect to the yz plane. A direction in which the virtual plane 51B′ is inclined with respect to the yz plane is opposite to a direction in which the virtual plane 51A′ is inclined with respect to the yz plane.

The spin inductor 102 according to the second embodiment exhibits the same effects as the spin inductor 101 according to the first embodiment. When a lateral surface of the laminated body 51 has a stepped shape, a contact area between the first terminal 60 and the laminated body 51 and a contact area between the second terminal 70 and the laminated body 51 can be sufficiently secured.

Further, in the spin inductor 102 according to the second embodiment, while both the first lateral surface 51A and the second lateral surface 51B have the stepped shape, any one of them may have the stepped shape.

### Third Embodiment

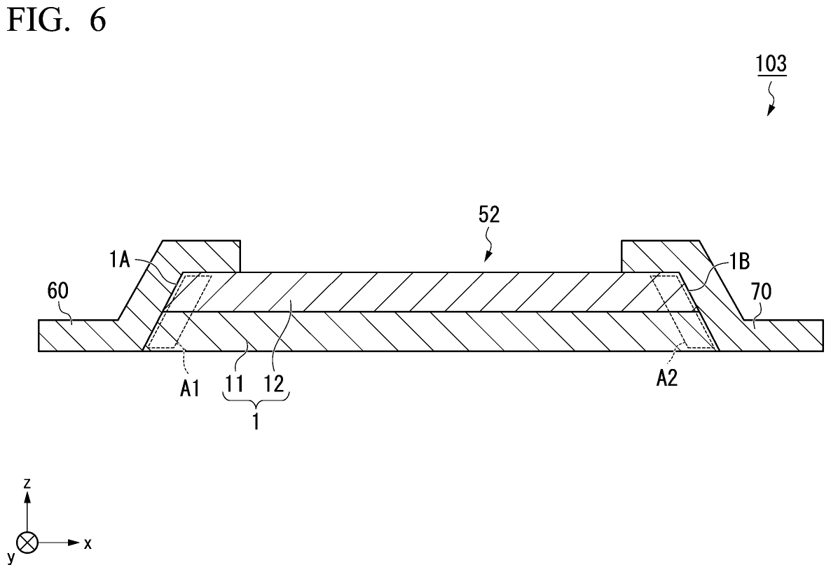

FIG. 6 is a cross-sectional view of a spin inductor 103 according to a third embodiment. In the spin inductor 103 according to the third embodiment, the same components as in the spin inductor 101 according to the first embodiment are designated by the same reference signs, and description thereof will be omitted.

The spin inductor 103 according to the third embodiment has a laminated body 52, a first terminal 60, and a second terminal 70. The laminated body 52 is distinguished from the laminated body 50 in that it is constituted by only the first inductor layer 1. The laminated body 52 may have the first region A1 and the second region A2 like in the laminated body 50.

A first lateral surface 1A of the first inductor layer 1 is inclined in the z direction. The first lateral surface 1A is inclined with respect to the yz plane. The first lateral surface 1A coincides with a virtual plane that connects a first end side of the upper surface of the first inductor layer 1 in the x direction and a first end side of the lower surface of the first inductor layer 1 in the x direction.

A second lateral surface 1B of the first inductor layer 1 is inclined in the z direction. The second lateral surface 1B is inclined with respect to the yz plane. The second lateral surface 1B coincides with a virtual plane that connects a second end side of the upper surface of the first inductor layer 1 in the x direction and a second end side of the lower surface of the first inductor layer 1 in the x direction.

The spin inductor 103 according to the third embodiment exhibits the same effects as in the spin inductor 101 according to the first embodiment.

### Fourth Embodiment

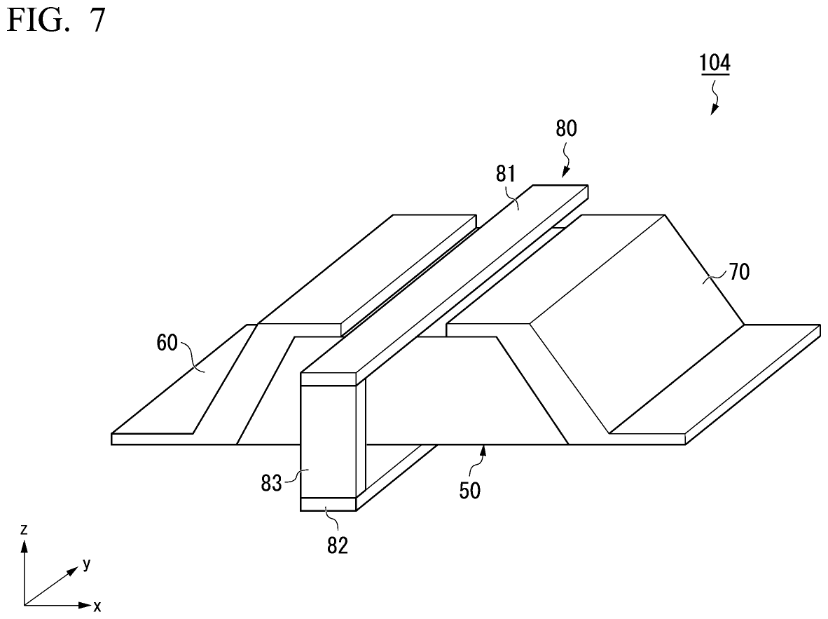

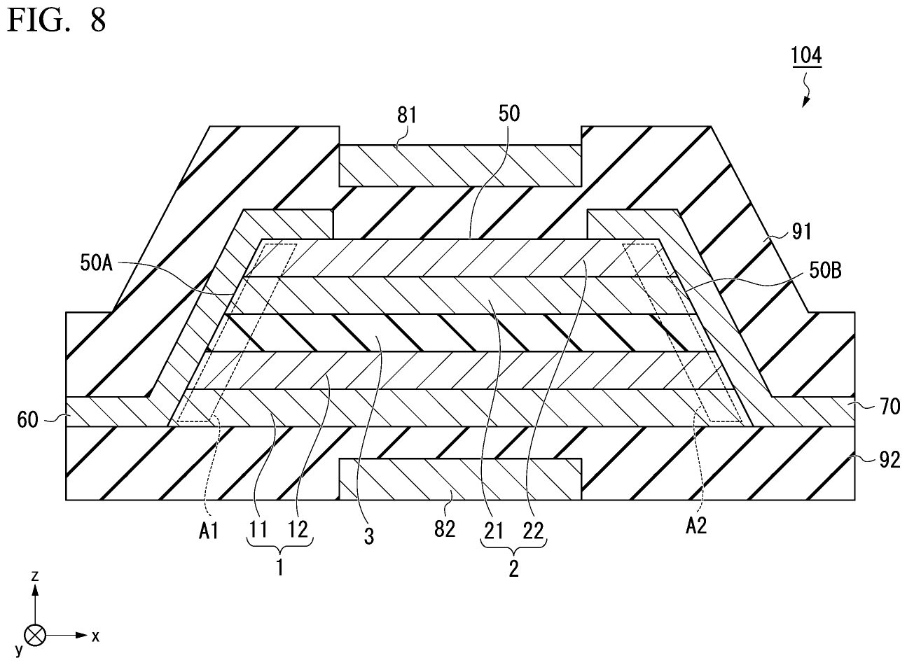

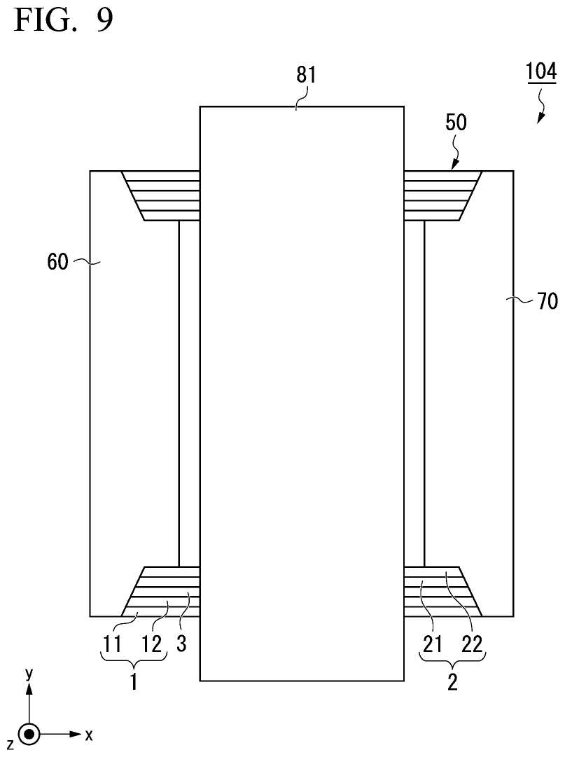

FIG. 7 is a perspective view of a spin inductor 104 according to a fourth embodiment. FIG. 8 is a cross-sectional view of the spin inductor 104 according to the fourth embodiment. FIG. 9 is a plan view of the spin inductor 104 according to the fourth embodiment. In the spin inductor 104 according to the fourth embodiment, the same components as in the spin inductor 101 according to the first embodiment are designated by the same reference signs, and description thereof will be omitted.

The spin inductor 104 has a laminated body 50, a first terminal 60, a second terminal 70, a yoke 80, an insulating layer 91, and an insulating layer 92. The spin inductor 104 is distinguished from the spin inductor 101 in that the yoke 80 is provided.

The yoke 80 has a first yoke layer 81, a second yoke layer 82, and a via 83.

The first yoke layer 81 is separated from the laminated body 50 in the z direction. The first yoke layer 81 is separated from the first inductor layer 1 in the z direction.

For example, the insulating layer 91 is provided between the laminated body 50 and the first yoke layer 81. The insulating layer 91 is an insulating layer that insulates the laminated body 50 and the yoke 80. The insulating layer 91 is formed of, for example, silicon oxide (SiOₓ), silicon nitride (SiNₓ), silicon carbide (SiC), chromium nitride, silicon carbonitride (SiCN), silicon oxynitride (SiON), aluminum oxide (Al₂O₃), zirconium oxide (ZrOₓ), magnesium oxide (MgO), aluminum nitride (AlN), or the like.

The second yoke layer 82 is separated from the laminated body 50 in the z direction. The first yoke layer 81 and the second yoke layer 82 sandwich the laminated body 50 in the z direction. The first yoke layer 81 and the second yoke layer 82 sandwich the first inductor layer 1 in the z direction.

For example, the insulating layer 92 is provided between the laminated body 50 and the second yoke layer 82. The insulating layer 92 is an insulating layer that insulates the laminated body 50 and the yoke 80. The insulating layer 92 contains the same material as in the insulating layer 91.

The first yoke layer 81 and the second yoke layer 82 suppress the laminated body 50 from receiving an influence of the magnetic field from the outside. In addition, in the first yoke layer 81 and the second yoke layer 82, the magnetization M1 of the first ferromagnetic layer 12 and the second ferromagnetic layer 22 is likely to be oriented in the z direction. When the magnetization M1 is strongly oriented in the z direction, an axis of the precession of the magnetization M1 is stabilized, and the spin inductor 104 shows a large inductance.

The via 83 connects the first yoke layer 81 and the second yoke layer 82. When the first yoke layer 81 and the second yoke layer 82 are connected by the via 83, a magnetic flux circulates along the yoke 80. As a result, the magnetization M1 is more strongly oriented in the z direction, and the spin inductor 104 shows a large inductance.

The spin inductor 104 according to the fourth embodiment exhibits the same effects as in the spin inductor 101 according to the first embodiment. In addition, as described above, since the precession of the magnetization M1 is stabilized by the yoke 80, the spin inductor 104 has a large inductance.

### REFERENCE SIGNS LIST

1 First inductor layer
2 Second inductor layer
3 Spacer layer
11 First wiring layer
12 First ferromagnetic layer
21 Second wiring layer
22 Second ferromagnetic layer
11A, 21A First surface
11B, 21B Second surface
50, 51, 52 Laminated body
50A, 51A, 1A First lateral surface
50B, 51B, 1B Second lateral surface
51A′, 51B′ Virtual plane
60 First terminal
70 Second terminal
80 Yoke
81 First yoke layer
82 Second yoke layer
83 Via
91, 92 Insulating layer
101, 102, 103, 104 Spin inductor
A1 First region
A2 Second region

1. A spin inductor comprising:
a first inductor layer having a first wiring layer and a first ferromagnetic layer in contact with the first wiring layer;
a first terminal in contact with a first lateral surface of the first inductor layer; and
a second terminal in contact with a second lateral surface different from the first lateral surface of the first inductor layer,
wherein a virtual plane that connects a top edge and a bottom edge of the first lateral surface is inclined in the laminating direction.

2. The spin inductor according to claim 1, wherein each of the first terminal and the second terminal is in contact with both the first wiring layer and the first ferromagnetic layer.

3. The spin inductor according to claim 1, further comprising a spacer layer in contact with the first inductor layer.

4. The spin inductor according to claim 3, further comprising a second inductor layer including a second wiring layer and a second ferromagnetic layer in contact with the second wiring layer,
wherein the spacer layer is sandwiched between the first ferromagnetic layer and the second wiring layer.

5. The spin inductor according to claim 1, wherein the first wiring layer has a length in a first direction in which the first terminal and the second terminal are connected, which is smaller than a length in a second direction perpendicular to the first direction.

6. The spin inductor according to claim 1, wherein the first lateral surface has a stepped shape.

7. The spin inductor according to claim 1, wherein the first lateral surface is an inclined surface.

8. The spin inductor according to claim 1, further comprising a first yoke layer,
wherein the first yoke layer is separated from the first inductor layer in the laminating direction.

9. The spin inductor according to claim 8, further comprising a second yoke layer,
wherein the first yoke layer and the second yoke layer sandwich the first inductor layer in the laminating direction.

10. The spin inductor according to claim 9, further comprising a via that connects the first yoke layer and the second yoke layer.

11. The spin inductor according to claim 1, wherein the first inductor layer has a first region in contact with the first terminal, and
in the first region, at least one of the first wiring layer and the first ferromagnetic layer contains an atom that constitutes the first terminal.

12. The spin inductor according to claim 1. wherein the first wiring layer is configured to inject spins into the first ferromagnetic layer and be capable of causing precession of magnetization of the first ferromagnetic layer.
